(19) United States
(12) Patent Application Publication
(10) Pub. No.: US 2022/0177745 A1
(43) Pub. Date: Jun. 9, 2022

(54) FILM WITH STRUCTURED ADHESIVE AND STRUCTURED LINER AND METHOD OF MAKING

(71) Applicant: 3M INNOVATIVE PROPERTIES COMPANY, St. Paul, MN (US)

(72) Inventors: Cordell M. Hardy, Woodbury, MN (US); Guy M. Kallman, Woodbury, MN (US)

(21) Appl. No.: 17/604,810

(22) PCT Filed: Apr. 22, 2020
(86) PCT No.: PCT/IB2020/053805

§ 371 Date: Oct. 19, 2021

Related U.S. Application Data
(60) Provisional application No. 62/837,069, filed on Apr. 22, 2019.

(51) Int. Cl. C09J 7/40; C09J 7/38; C09J 11/04

(52) U.S. Cl. CPC C09J 7/405; C09J 7/385; C09J 2433/00; C09J 11/04; C09J 2423/045; C09J 7/401

(57) ABSTRACT

Films with structured adhesives and structured liners are described. Associated methods of making such films are also described. Films as described herein may be particularly suitable to providing adhesive films with structured adhesives with readily recyclable liners.

### BACKGROUND

Films having structured adhesive layers may exhibit desirable qualities such as air bleedability or repositionability. A liner is attached to the other side of adhesive to permit the film to be stored and handled before its removal and the adhering of the film to a surface.

### SUMMARY

In one aspect, the present description relates to a film. The film includes a substrate with a first major surface and a second major surface, an adhesive layer disposed on the second major surface, and a release liner disposed on the adhesive layer opposite from the substrate. The adhesive layer has a first structure pattern and the release liner has a second structure pattern. The first structure pattern and the second structure pattern are not the inverse of or the same as each other.

In another aspect, the present description relates to a film. The film includes a substrate with a first major surface and a second major surface, an adhesive layer disposed on the second major surface, and a release liner disposed on the adhesive layer opposite from the substrate. The adhesive layer has a first structure pattern and the release liner has a second structure pattern. Due to the second structure pattern, a gap is present between the adhesive layer and the portions of release liner.

In yet another aspect, the present description relates to a method. The method includes providing a substrate with a first major surface and a second major surface, applying an adhesive layer on the second major surface and embossing the adhesive layer with a first liner to form a structured adhesive layer having a first structure pattern. The method further includes removing the first liner and attaching a second liner having a second structure pattern to the structured adhesive layer. The second structure pattern is not the inverse of or the same as the first structure pattern.

### BRIEF DESCRIPTION OF THE DRAWINGS

FIG. 1 is a schematic side elevation cross-section of a film with structured adhesive and a structured liner.

FIG. 2 is a schematic side elevation cross-section of a film having a structured adhesive formed by an intermediate structured liner.

FIG. 3 is a schematic side elevation cross-section of a film having a structured adhesive formed by a structured continuous belt.

### DETAILED DESCRIPTION

Adhesive films, such as graphics or “wrap” films used for customizing the appearance of a building, an interior environment, or a vehicle are typically shipped with a liner attached to the adhesive side. The liner is selected to prevent the film from adhering to itself or to any surface other than the desired application substrate. Since the film is often indented to be permanently or semi-permanently applied to the application substrate (i.e., not to be later repositioned), the liner serves an important role by preventing unintentional sticking. The liner is often carefully designed and its material in contact with the adhesive particularly selected in order to provide an easy release (i.e., a low required peel force). Often, a silicone layer is provided at the interface between the adhesive and the liner to provide a good release characteristic.

Certain films include a structured adhesive, with microfeatures that can provide application features such as airbleed and slideability (e.g., IJ180Cv3 from 3M Company, with Comply™ and Controltac™ adhesive). In some cases, these structured features are formed by mating a structured liner to a substantially featureless adhesive layer. The features are embossed—and the adhesive receives a structured pattern that is the inverse of the structured liner. For example, in order to make channels in an adhesive layer, one would mate a structured liner having ridges. This structured interface surface provides even more contact surface area between the liner and the adhesive, and therefore the design is even more reliant on the selection of the liner material for an ultimate acceptable release.

Because the liner is removed at or very close to the time and place of ultimate application, the removed liner is typically left to be disposed of by the customer. Because the liners cover the entire film, the waste stream can be considerable: a footprint of at least the area of the film used must be disposed. Additionally, to achieve acceptable release characteristics as described above, materials such as silicone or even polytetrafluoroethylene are used. These materials are not (at least currently) commercially recyclable and are therefore incinerated or landfilled.

Previously, it was believed that commercially recyclable liners would not be technically possible on a structured adhesive because of the high (relative to other release materials) surface energy of the recyclable plastics. Such constructions were assumed to be unsuitable because they would either not release from the adhesive or because they would require excessive force to peel off the release liner.

Surprisingly, it has been found that acceptable release characteristics may be achieved by providing structure to the adhesive layer by a first release liner, removing that release liner, and attaching a second liner (which may be recyclable) with a different structured surface. The structured surface of the second liner limits the surface area contact between the liner and the adhesive and therefore maintains a low required peel force for removal.

While certain embodiments of the described process and related articles may require the use of a first liner and a second liner, there may be realizable advantages in using the technique highlighted herein. First, a manufacturing location or factory may be able to take advantage of specialty recycling programs that are not available to individual, small volume customers. Liners removed at the manufacturing site may be reusable. In some embodiments, the first liner is replaced with an embossing roll or a continuous belt, removing the requirement for two separate single use liners.

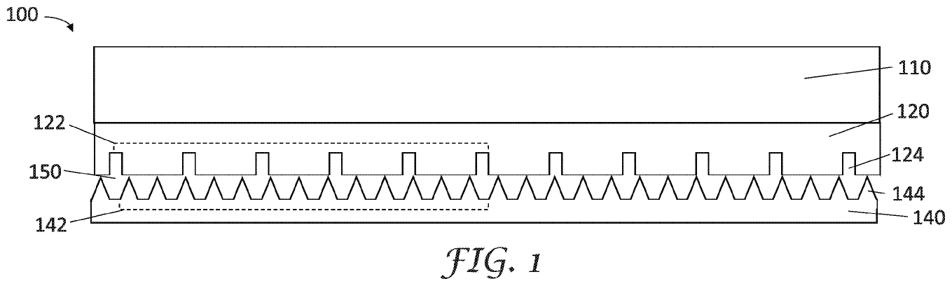

FIG. 1 is a schematic side elevation cross-section of a film with structured adhesive and a structured liner. Film 100 includes film substrate 110, structured adhesive layer 120 including first structure pattern 122 including adhesive microfeature 124, structured liner 140 including second structure pattern 142 including liner microfeature 144. Gap 150 is present between the structured liner and the structured adhesive layer.

Film substrate 110 may be any suitable film substrate. In some embodiments, film substrate 110 may be a vinyl (polyvinyl chloride) film substrate. In some embodiments, film substrate 110 may be a thermoplastic polyurethane blended with cellulose acetate butyral or cellulose acetate propionate. In some embodiments, film substrate 110 may be a thermoplastic polyurethane blended with polyvinyl butyral. Any other polymer or blend of polymers may also be used. Film substrate 110 may be selected for its conformability, stretchability, or other physical characteristics. In some embodiments, film substrate may be printable, either by inkjet printer, latex printer, solvent printer, or any other printer. The substrate itself may be printable or it may optionally have an ink receptive layer on the printable surface. Film substrate 110 may be any suitable thickness, and may have its thickness selected based on desired flexibility, stretchability, conformability, handling, or other properties. Suitable thicknesses may be between 20 and 500 micrometers. In some embodiments, film substrate 110 may be smooth and substantially featureless, or in some embodiments, film substrate 110 may have a surface texture, such as a matte appearance. In some embodiments, film substrate 110 may be clear, and in some embodiments, film substrate 110 includes pigments, dyes, or other colorants (including white).

Structured adhesive layer 120 may be any suitable adhesive. Structured adhesive may be coated onto film substrate 110 or laminated to film substrate 110. In some embodiments, structured adhesive layer may have sufficient structure to maintain its shape (i.e., to not flow) over a range of exposure temperatures and humidities. In some embodiments, the adhesive may be an acrylic adhesive. In some embodiments, the adhesive may be a pressure sensitive adhesive. In some embodiments, the adhesive may be fully or partially crosslinked. The structured layer may include a pigment, dye, or other colorant. The structured adhesive layer may be any suitable thickness. In some embodiments, the thickness of the structured adhesive layer may be between 10 and 100 micrometers. In some embodiments, structured adhesive layer 120 may include partially embedded microbeads, made from materials such as glass, ceramic, or polymeric resin or agglomerations thereof held together with a suitable binder material. In some embodiments, the microbeads may be index matched to the structured adhesive and/or be transparent.

Structured adhesive layer 120 includes first structure pattern 122 including adhesive microfeature 124. First structure pattern 122 may be any suitable or desired pattern. In FIG. 1, the pattern shown is regular, with each of microfeature 124 being the same size and space apart. However, this is not necessary and any regular, irregular (non-periodic, or even pseudo-random or random) pattern may be used, and the size and shape of each of adhesive microfeature 124 may, in some embodiments vary smoothly or stepwise across one or more dimensions of the film. In some embodiments, first structure pattern 122 is a one-dimensional pattern, meaning that it does not vary along more than one dimension (for example, in the pattern shown in FIG. 1, the microfeature is the same shape and size in the directions in and out of the page). Alternatively, first structure pattern 122 may be a two-dimensional pattern, where the features are placed in, for example, a matrix or grid. In some embodiments, adhesive microfeature 122 may be a linear channel. In some embodiments, adhesive microfeature 122 may be a curved channel. The cross-sectional shape of adhesive microfeature may be substantially rectangular (as shown in FIG. 1) or it have other suitable shapes, such as triangular or hemispherical. In some embodiments, the depth of the adhesive microfeature may be no more than 95%, or no more than 90%, or no more than 80%, or no more than 70%, or no more than 60%, or no more than 50%, or no more than 40%, or no more than 30%, or no more than 20%, or no more than 10% of the thickness of the structured adhesive layer.

Structured liner 140 may be made from any suitable material and via any suitable process. In some embodiments, structured liner 140 may be microreplicated (such as through a continuous cast-and-cure process), embossed, injection molded, or even additively manufactured (i.e., 3-D printed). In some embodiments, structured liner 140 may be formed substantially from a commercially recyclable material. For example, structured liner 140 may be formed substantially from high density polyethylene, low density polyethylene, polyvinyl chloride, polystyrene, or polypropylene. In some embodiments, the structured liner 140 is formed from a material having a surface energy equal or less than 35 mJ/m² (equivalent to dynes/cm).

In some embodiments, structured liner 140 includes no materials or additional layers or coatings that render it unsuitable for commercial recycling. In some embodiments, the structured liner is marked with a resin identification code to aid in identification for recycling.

Structured liner 140 includes second structure pattern 142 including liner microfeature 144. As for first structure pattern 122, second structure pattern 142 may be any suitable pattern, including any size or shape microfeature or combinations of microfeatures. In some embodiments, second structure pattern 142 is regular, as shown in FIG. 1, with each of the liner microfeatures being the same size and evenly spaced apart. Of course, any regular, irregular (non-periodic, pseudo-random, or random) pattern may be used. The size and shape of the liner microfeature may vary (smoothly or stepwise) across one or more dimensions of the film. In some embodiments, second structure pattern 142 is a one-dimensional pattern. In some embodiments, second structure pattern 142 is a two-dimensional pattern. In some embodiments, the cross-sectional shape of liner microfeature 144 is substantially triangular or prismatic (as shown in FIG. 1). In some embodiments, liner microfeature 144 includes extended tips (a second, narrower prism atop the base prism shape).

Additionally, due to the shape of the second structure pattern, there is a gap present between at least portions of structured liner 140 and structured adhesive layer 220. Gap 150 may include air or any other ambient gas. The size and shape of the microfeatures and, accordingly, the general arrangement of second structure pattern 142 depends on the application and desired performance. It will be apparent to the person skilled in the art that the pattern may be selected to create a desirable surface contact area between the structured liner and the structured adhesive and to provide a desired liner release peel. More surface area contact will generally result in a stronger bond between the liner and the adhesive.

It is important to note that the first structure pattern and the second structure pattern are neither the same nor the inverse of each other. At least one characteristic of the patterns should be different from one another. For example, the structured liner's second structure pattern may be ridges, and the structure adhesive's first structure pattern may be channels, but they may have different feature sizes, pitches, or alignment (i.e., the microfeatures may be biased along a different axis). In this case, the first structure pattern and the second structure pattern would not be the same or the inverse of one another. Of course, more than one characteristic may be different between the first and second structure pattern.

Certain selections of the shape and size of the structures—and the thickness and flowability of the adhesive—may help to prevent the adhesive fully wetting out the surface structure, thereby reducing the effect that closely mated structures may have on release. For example, in some embodiments, the structures of the second structure pattern are shaped and sized such that the structure pattern displaces more volume per unit area between the bearing surface and the planar land region than the adhesive volume for that same unit area.

Film 100 may be provided in any suitable form, including converted sheets cut to predetermined sizes or, in some embodiments, in a roll form. Subsequent processing, e.g., printing or overlamination may be carried out on the film in either form. In some embodiments, film 100 is a large format graphic, and has a longest dimension of at least one meter.

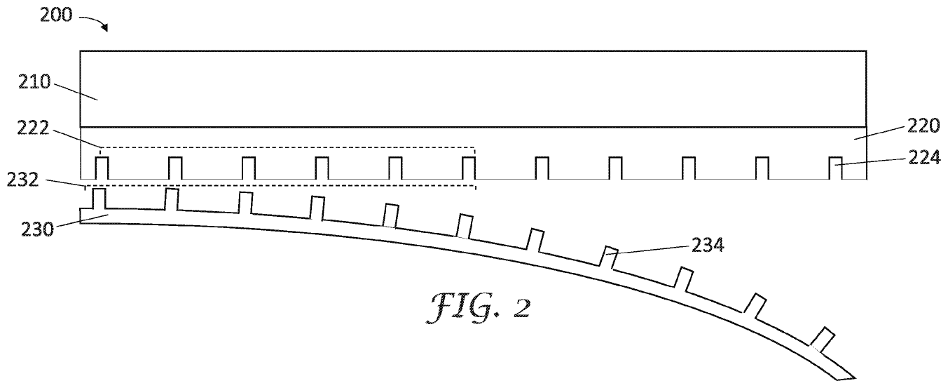

FIG. 2 is a schematic side elevation cross-section of a film having a structured adhesive formed by an intermediate structured liner. Film 200 includes film substrate 210, structured adhesive layer 220 including first structure pattern 222 including adhesive microfeature 224, and intermediate liner 230 including second structure pattern 232 including liner microfeature 234.

Film substrate 110 and structured adhesive layer 120 correspond to film substrate 210 and structured adhesive layer 220. Intermediate liner 230, however, is intended to provide the structure to structured adhesive layer 220 without permanently adhering to the adhesive layer. Accordingly, intermediate liner is made from a suitable material such that the release of intermediate liner 230 from structured adhesive layer 220 does not damage or deform the first structure pattern.

In some embodiments, intermediate liner is a polymer coated with elastomeric silicone such that the silicone is in contact with the adhesive layer when the two are joined. In some embodiments, the intermediate liner is a polymer coated paper. In some embodiments, the intermediate liner includes a coating of polytetrafluoroethylene. In some embodiments, the intermediate liner includes a polyester block copolymer. The intermediate liner may be formed by any suitable method, such as microreplication, embossing, injection molding, or additive manufacturing. Multiple process steps may also be used; especially, for example, if a second material is coated over the base film.

The intermediate liner is attached to the adhesive layer which provides the structure to the structured adhesive layer. As such, the first structure pattern of the adhesive is the inverse of the second structure pattern provided on the intermediate liner. In some embodiments, the intermediate liner also includes or carries microbeads. In some embodiments, the adhesive may be partially cured while attached to the intermediate liner.

Certain selections of the shape and size of the structures—and the thickness and flowability of the adhesive—may help to prevent the adhesive fully wetting out the intermediate liner surface structure. For example, in some embodiments, structures are shaped and sized such that the structure displaces more volume per unit area between the bearing surface and the planar land region than the adhesive volume for that same unit area.

The intermediate liner is subsequently removed from the film construction. The liner may be removed before or after the film is converted; i.e., it may be separated in a continuous process or it may be performed in batches. After removing the intermediate liner, a structured liner such as structured liner 140 shown in FIG. 1 is laminated or attached to the exposed structured adhesive layer. In some embodiments, the structured liner has a higher surface energy than the intermediate liner.

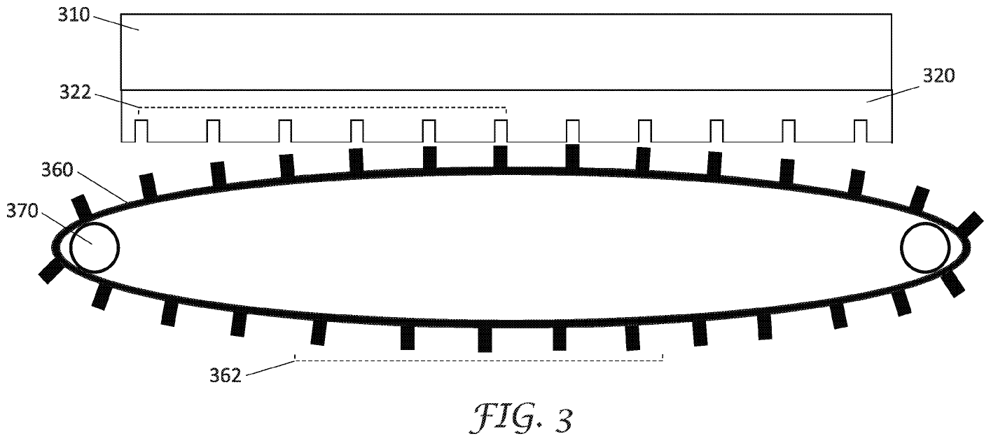

FIG. 3 is a schematic side elevation cross-section of a film having a structured adhesive formed by a structured continuous belt. The film includes film substrate 310 and structured adhesive layer 320 including first structure pattern 322. The film's adhesive layer is structured by continuous belt 360 with second structure pattern 362 disposed on rollers 370. Similarly to the intermediate liner described in conjunction with FIG. 2, the continuous belt is used to impart the first structure pattern 322 on structured adhesive layer 320. In a film line process, the substrate film and structured adhesive layer (film substrate 310 and structured adhesive layer 320 are only a section of a continuous web of material) pass by the continuous belt and the continuous belt contacts the adhesive layer. The inverse of the second structure pattern 362 is provided on the structured adhesive layer as first structure pattern 322. In some embodiments, the second structure pattern has structures that are shaped and sized such that the structure pattern displaces more volume per unit area between the bearing surface and the planar land region than the adhesive volume for that same unit area.

The belt and film should be travelling in the machine direction at approximately the same speed, so the pattern can be accurately applied to the adhesive layer. The adhesive may be partially cured while in contact with the structured continuous belt.

The structured continuous belt is provided on at least one rollers 370. In some embodiments, structured continuous belt 360 is provided on two rollers. At least one of the rollers is powered and rotates the structured continuous belt at the desired speed. The structured continuous belt may be any suitable material and formed from any suitable process. For example, the structured belt may or include a rigid material coated with elastomeric silicone.

In some embodiments, using a continuous belt provides the advantage of not attaching and detaching an intermediate liner. In some embodiments, using a continuous belt can effectively integrate the liner replacement process into the film manufacturing line without creating waste. As was described in conjunction with the process illustrated in FIG. 2, a structured liner such as structured liner 140 shown in FIG. 1 is attached to the exposed structured adhesive layer. In some embodiments, the structured liner has a higher surface energy than the structured continuous belt.

Descriptions for elements in figures should be understood to apply equally to corresponding elements in other figures, unless indicated otherwise. The present invention should not be considered limited to the particular embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

### EXAMPLES

### Materials Used in the Examples

| Abbreviation | Description and Source |
|---|---|
| 1080 White | 3M Wrap Film 1080-G10 gloss white. Cast vinyl film |
| | designed for solid color passenger vehicle detailing; |
| | approximately 3.5 mil (0.09 mm) film thickness. The |
| | film contains structured, 3M CONTROLTAC |
| | repositionable pressure activated adhesive |
| | (includes ceramic beads) and 3M COMPLY v3 |
| | adhesive non-visible air release channels, with an |
| | approximate adhesive thickness of 1 mil (0.025 mm). |
| | Available from 3M Company, St. Paul, MN. |
| PE Liner | 309098 LDPE film in blue (75 micrometer thickness, |
| | with D124 embossed texture: approximately 1 mm |
| | equilateral triangular pyramids). Available from |
| | Infiana USA, Malvern, Pa. |

### Test Methods

Film lamination: The paper liner of the 1080 White film was removed and the adhesive side of 1080 White film was laminated to the structured side of the PE Liner. Then the PE Liner was removed, and the 1080 White film laminated to a glass substrate by hand with a hand roller approximately 10 lb in weight.

Peel (liner release force) test: The film sample, laminated to the PE Liner, was cut into a strip approximately ½″ in width and mounted to an I-MASS SP-2000 peel tester (Accord, Mass.) in the 180 degree orientation. The peel force was measured at a speed of 12 inches/minute.

### EXAMPLE

The 1080 White film was laminated to the textured PE Liner using the test method above. After approximately 3 minutes of dwell time, the film was removed from the textured liner (PE Liner) and laminated in the same method to a smooth glass substrate. The film was easily applied without air bubbles, showing that the air release channels were still present on the adhesive. The texture of the PE Liner was shown through the film and could be observed visually while the 1080 White film was on the PE Liner. However, once the 1080 White film was removed from the textured PE Liner and laminated to a smooth substrate, the textures were smoothed out and were no longer visually observable.

After approximately 3 minutes of dwell time, the 1080 White film was removed by hand from the glass substrate. The 1080 White film removed cleanly from the glass substrate without leaving residue, showing that the 1080 White film retained its repositionable properties.

The peel force (liner release force) was measured using a peel tested as described above. Three samples were tested and the average peel force results are reported in Table 1 below. These results represent generally acceptable values.

| | 180 degree liner release | |
|---|---|---|
| Liner | force, average (oz/in) | Peel front |
| PE Liner | 2.75 ± 0.36 | Slightly shocky |

1. A film, comprising:
a substrate with a first major surface and a second major surface;
an adhesive layer disposed on the second major surface; and
a release liner disposed on the adhesive layer opposite from the substrate;
wherein the adhesive layer has a first structure pattern;
wherein the release liner has a second structure pattern; and
wherein the first structure pattern and the second structure pattern are not the inverse of or the same as each other.

2. A film, comprising:
a substrate with a first major surface and a second major surface;
an adhesive layer disposed on the second major surface; and
a release liner disposed on the adhesive layer opposite from the substrate;
wherein the adhesive layer has a first structure pattern;
wherein the release liner has a second structure pattern;
wherein, due to the second structure pattern, a gap is present between the adhesive layer and portions of the release liner.

3. The film of claim 1, wherein the release liner is commercially recyclable.

4. The film of claim 1, wherein the release liner is formed from a polymer having a surface energy less than or equal to 35 mJ/m².

5. The film of claim 1, wherein the release liner is formed substantially from one of the group consisting of high density polyethylene, low density polyethylene, polyvinyl chloride, and polypropylene.

6. A roll of film, comprising the film of claim 1.

7. The film of claim 1, wherein one or both of the release liner and the adhesive layer includes beads.

8. The film of claim 7, wherein the second structure pattern has a period, the period having a length equal to or larger than an average diameter of the beads.

9. The film of claim 1, wherein the first structure pattern and the second structure pattern have different periods.

10. The film of claim 1, wherein the adhesive layer includes an acrylic adhesive.

11. The film of claim 1, wherein the first structure pattern is channels and the second structure pattern is prisms.

12. The film of claim 1, wherein both the first structure pattern and the second structure pattern are one dimensional patterns.

13. The film of claim 1, wherein the second structure displaces more volume per unit area between a bearing surface of the release liner and a planar land region of the release liner than a volume of the adhesive layer for the same unit area.

14. A method, comprising:
providing a substrate with a first major surface and a second major surface;
applying an adhesive layer on the second major surface;
embossing the adhesive layer with a first liner to form a structured adhesive layer having a first structure pattern;
removing the first liner;
attaching a second liner having a second structure pattern to the structured adhesive layer, the second structure pattern not being the inverse of or the same as the first structure pattern.

15. The method of claim 14, wherein the first liner includes silicone.

16. The method of claim 14, wherein the first liner is a belt.

17. The method of claim 14, wherein the first liner and the second liner are different materials.

18. The method of claim 14 wherein the second liner is formed essentially from one of the group consisting of high density polyethylene, low density polyethylene, polyvinyl chloride, and polypropylene.

19. (canceled)

20. The method of claim 14, further comprising winding the film onto a roll.

21. (canceled)

22. The method of claim 14, wherein the second liner has a higher surface energy than the first liner.
